(19) United States
(12) Patent Application Publication
(10) Pub. No.: US 2013/0215605 A1
(43) Pub. Date: Aug. 22, 2013

(54) HIGH-PERFORMANCE HEAT DISSIPATING LAMP

(71) Applicant: UNITY OPTO TECHNOLOGY CO., LTD., (US)

(72) Inventors: CHIH-HSIEN WU, NEW TAIPEI CITY (TW); PAI-YAO HSIEH, NEW TAIPEI CITY (TW); SEN-YUH TSAI, NEW TAIPEI CITY (TW); CHI-YU HUNG, NEW TAIPEI CITY (TW)

(73) Assignee: UNITY OPTO TECHNOLOGY CO., LTD., NEW TAIPEI CITY (TW)

(21) Appl. No.: 13/743,497

(22) Filed: Jan. 17, 2013

(30) Foreign Application Priority Data
Feb. 21, 2012 (TW) 101203107

(51) Int. Cl. F21V 29/00

(52) U.S. Cl. CPC F21V 29/2293
USPC 362/184

(57) ABSTRACT

In a high-performance heat dissipating lamp, a heat dissipating module is clamped between a substrate having a plurality of power supply devices and a lamp base having a plurality of LED modules to separate the power supply devices and the LED modules, and the LED module are arranged with a gap apart from each other, and coupled to the power supply devices one by one, so that heat released from the LED module or the power supply device will not be accumulated in a single circuit board, and the airflow between the LED module and the power supply device can flow faster to improve the heat dissipating efficiency, while each separate power supply device and each separate LED module can facilitate maintenance and repair, or replacement of components.

### CROSS-REFERENCE TO RELATED APPLICATIONS

This non-provisional application claims priority under 35 U.S.C. §119(a) on Patent Application No(s). 101203107 filed in Taiwan, R.O.C. on Feb. 21, 2012, the entire contents of which are hereby incorporated by reference.

### BACKGROUND OF THE INVENTION

1. Field of the Invention

The present invention relates to the technical area of illumination devices, in particular to a high-performance heat dissipating lamp that uses a plurality of circuit boards to carry and install a plurality of light emitting diodes (LEDs) respectively to form a plurality of separate LED modules, so as to prevent heat released by the LEDs from being concentrated on a single circuit board and affecting the heat dissipating efficiency, and each LED module is equipped with an independent power supply component to facilitate maintenance and repair.

2. Description of the Related Art

With the advantages of low power consumption, long life, small volume, quick response, reasonable price and popular application, light emitting diodes (LEDs) hit the entire illumination market and become popular in home and public illumination apparatuses such as light bulbs, light tubes, automobile lamps, and traffic signal lights. As the market requirement of illumination brightness becomes increasingly higher, the power requirement of the LEDs also becomes higher, and the heat generated by the operation of the LEDs increases the overall temperature of the illumination apparatuses significantly. Since that, if the heat dissipating efficiency of the apparatuses is low, the heat will affect the service life and the light emitting efficiency of LEDs greatly. Therefore, most conventional LED lamps adopt a fin-type heat dissipating element installed at a backlight surface of the LED which is the bottom of the lamp to increase the heat dissipating surface to improve the heat dissipating efficiency.

However, a plurality of LEDs is generally installed on a single circuit board of the conventional LED lamp, and a power circuit on the circuit board is coupled to a power supply device to supply electric power to the LEDs to emit light, such that the heat released from the LEDs is usually concentrated at the circuit board and cannot be dissipated easily. In addition, some of the electric power of the power circuit are converted into heat, and thus causing a high temperature due to the large quantity of heat accumulated at the circuit board, resulting in abnormal operations, a shortened service life, or low working performance of the circuits and components installed on the circuit board, and affecting the product quality and reliability of the LED lamps substantially. For lamps of high illumination, high power, and high power consumption such as a bay light used in large sites of factories, shopping malls, parking lots, gas stations, or stadiums, and the way of simply using the heat dissipating element for dissipating the heat cannot achieve the required heat dissipating efficiency, and will shorten the service life, so that the bay light installed or hanged to the ceiling through high-altitude operations is required, and manpower is wasted and operational cost is increased due to the frequent replacement of the lamps.

### SUMMARY OF THE INVENTION

In view of the problems of the prior art, it is a primary objective of the present invention to a high-performance heat dissipating lamp that uses a single circuit board to carry a single LED module formed by a single LED and then connects to a single power supply device, and the LED module and the power supply device are coupled and installed through the heat dissipating module, such that the LED module and the power supply device are separated from each other to prevent heat from being concentrated or accumulated, and the heat dissipating module clamped between the LED module and the power supply device can accelerate the heat dissipation to improve the heat dissipating effect.

To achieve the foregoing objectives, the present invention provides a high-performance heat dissipating lamp comprising a lamp cover, a plurality of power supply devices, a substrate, a heat dissipating module, a lamp base, a plurality of LED modules and a translucent plate, wherein a side of the substrate is coupled to a cover opening of the lamp cover, and the other side of the substrate is attached to a side of the heat dissipating module, and the other side of the heat dissipating module is attached to the lamp base, and the translucent plate is coupled and sealed onto a base opening of the lamp base. The substrate has a plurality of heat dissipating holes, and the power supply devices are installed on the substrate and covered inside the lamp cover. The lamp base has a containing space, and the LED modules are contained in the containing space and fixed to the lamp base, and the LED modules are coupled to the corresponding power supply devices one by one.

Wherein, the substrate is made of metal or plastic, and the lamp base is made of aluminum, and the lamp base has a plurality of airholes formed on a surface of the lamp base to expedite conducting the heat released from the power supply devices or the LED modules to the heat dissipating module. In addition, the heat dissipating module includes a plurality of heat dissipating elements arranged with a gap apart from one another and disposed along the periphery of the substrate, and the heat dissipating elements are a plurality of fishbone-shaped fins extended from a V-shaped center portion towards both ends of an opening respectively, such that each of the heat dissipating elements is in a fan shape symmetrically on both left and right sides. Therefore, a frame ring formed by arranging the heat dissipating elements in a circle will have a plurality of gaps which can assist circulating air inside and outside the lamp to form a thermal convection effect to improve the heat dissipating efficiency.

According to the principle of a rising hot airflow, the lamp cover has a plurality of penetrating holes formed on a surface of the lamp cover to further improve the heat dissipating efficiency, wherein the penetrating holes are in a circular cylindrical shape and arranged centripetally to allow hot air inside the lamp to be discharged from the top.

In addition, the present invention can be used in a bay light hung at a ceiling, such that the high-performance heat dissipating lamp further comprises a hanging rod and a hanging ring, and a through hole is formed separately at a center position of the lamp cover, the substrate and the lamp base, and the hanging rod is passed through the through holes and fixed to the hanging ring. With the hanging ring, the high-performance heat dissipating lamp can be installed for different occasions by a hanging method.

### BRIEF DESCRIPTION OF THE DRAWINGS

FIG. 1 is a top view of a preferred embodiment of the present invention;

FIG. 2 is an exploded view of a preferred embodiment of the present invention;

FIG. 3 is a schematic view of a preferred embodiment of the present invention; and

FIG. 4 is cross-sectional side view of a preferred embodiment of the present invention.

### DETAILED DESCRIPTION OF THE PREFERRED EMBODIMENTS

The technical contents of the present invention will become apparent with the detailed description of preferred embodiments and the illustration of related drawings as follows.

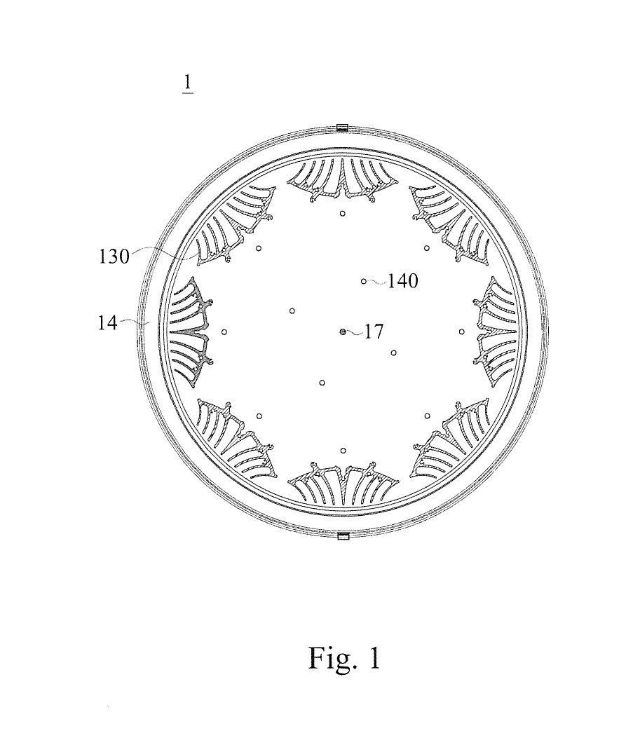

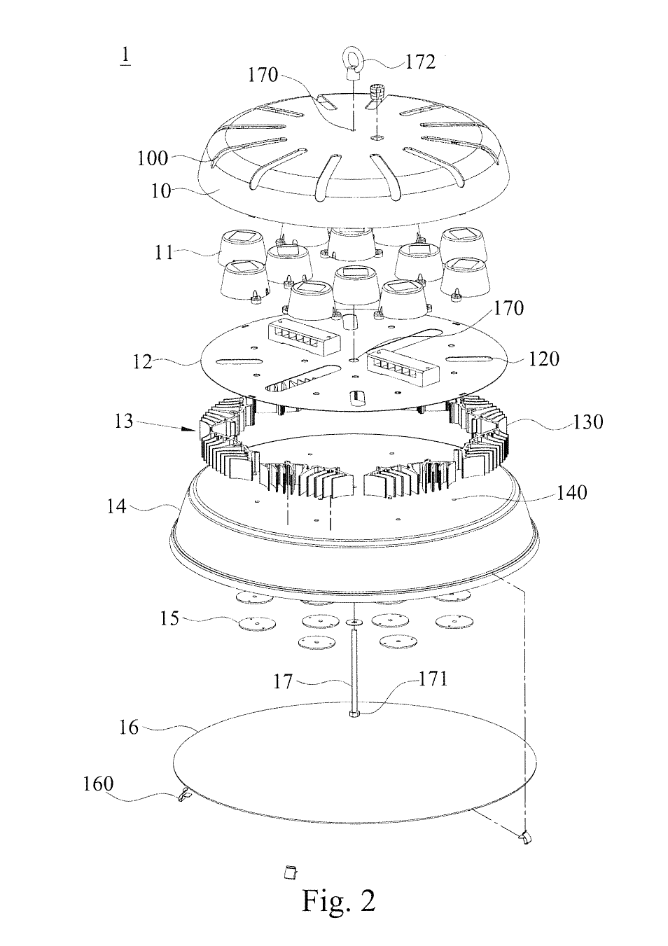

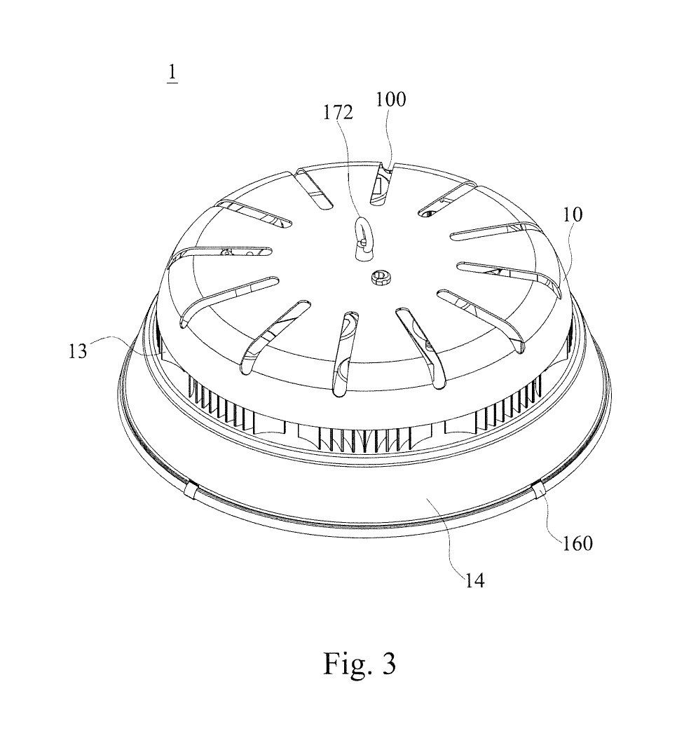

With reference to FIGS. 1 to 3 for a top view, an exploded view and a schematic view of a high-performance heat dissipating lamp in accordance with a preferred embodiment of the present invention respectively, the high-performance heat dissipating lamp 1 comprises a lamp cover 10, a plurality of power supply devices 11, a substrate 12, a heat dissipating module 13, a lamp base 14, a plurality of LED modules 15, a translucent plate 16 and a hanging rod 17. The lamp cover 10 has a through hole 170 formed at the center position of the lamp cover 10 and a plurality of penetrating holes 100 formed on a surface of the lamp cover 10. Each of the penetrating holes 100 is in a long cylindrical shape and the penetrating holes 100 are arranged centripetally. The substrate 12 is made of a plastic material or a metal material such as iron and used for retaining the power supply devices 11, and the substrate 12 includes a power circuit to form a power supply module, and a side of the substrate 12 is coupled to a cover opening of the lamp cover 10, such that the power supply devices 11 are covered inside the lamp cover 10, and the power supply devices 11 can be fixed onto the substrate 12 by a locking, embedding or adhering method. In addition, the substrate 12 has a through hole 170 corresponding to the through hole 170 formed at the center position of the lamp cover 10, and the substrate 12 also has a plurality of heat dissipating holes 120 which can be openings in any geometric shape (such as a long-strip shape or a circular shape) to cope with different heat dissipation requirements.

The lamp base 14 can be in form of a cover with a containing space, and has a plurality of circular airholes 140 formed on a surface of the lamp base 14, and the lamp base 14 has a through hole 170 corresponding to the through hole 170 formed at the center position of the substrate 12, and the containing space is provided for containing the LED modules 15, and the LED modules 15 can be fixed into the lamp base 14 by a locking, embedding or adhering method, and the LED modules 15 are coupled to the corresponding power supply devices 11 respectively. If any one of the LED modules 15 or any one of the power supply devices 11 is broken down or damaged, the bad LED module 15 or power supply device 11 can be replaced or repaired independently to reduce the level of difficulty and the cost of maintenance and repair.

In addition, a heat dissipating glue can be separately coated on both sides of the heat dissipating module 13 and attached onto the other side of the substrate 12 and the lamp base 14. In other words, the heat dissipating module 13 is just clamped between the lamp cover 10 and the lamp base 14, but not covered by either one, and the power supply devices 11 is heightened to separate the LED modules 15 in order to facilitate the circulation of air and expedite the heat dissipation. It is noteworthy to point out that the heat dissipating module 13 is a frame with a plurality of gaps formed by arranging a plurality of heat dissipating elements 130 along the periphery of the substrate 12 and separating the heat dissipating elements 130 with a gap apart from one another, and each of the heat dissipating elements 130 is aluminum extruded and its center position is V-shaped, and a plurality of fishbone-shaped fins are formed by extending in opposite directions from both ends of a V-shaped opening, so that the heat dissipating elements 130 are installed in a fan-shape symmetrically on both left and right sides, and the fins can be used to increase the heat dissipating area of the heat dissipating module 13 in order to expedite the heat dissipation. In addition, the gaps assist the air to circulate inside and outside the lamp to produce a thermal convection effect, so as to improve the heat dissipating efficiency.

In addition, the hanging rod 17 has a press-in part 171 formed at the distal end and provided for pressing the lamp base 14 after the handing rod 17 passed through the through holes 170 into the hanging rod 17, and the front end of the hanging rod 17 is fixed in a hanging ring 172 such as an eye nut after passed and installed to the lamp base 14, the substrate 12 and the lamp cover 10, so that the high-performance heat dissipating lamp 1 can be hanged to the ceiling of a factory, a shopping mall, a parking lot, a gas station, or a stadium and used as a bay light.

In this preferred embodiment, the translucent plate 16 is fixed by a plurality of snap-in clips 160 and sealed onto a base opening of the lamp base 14 to seal the LED modules 15 into the lamp base 14 to increase the light illumination area.

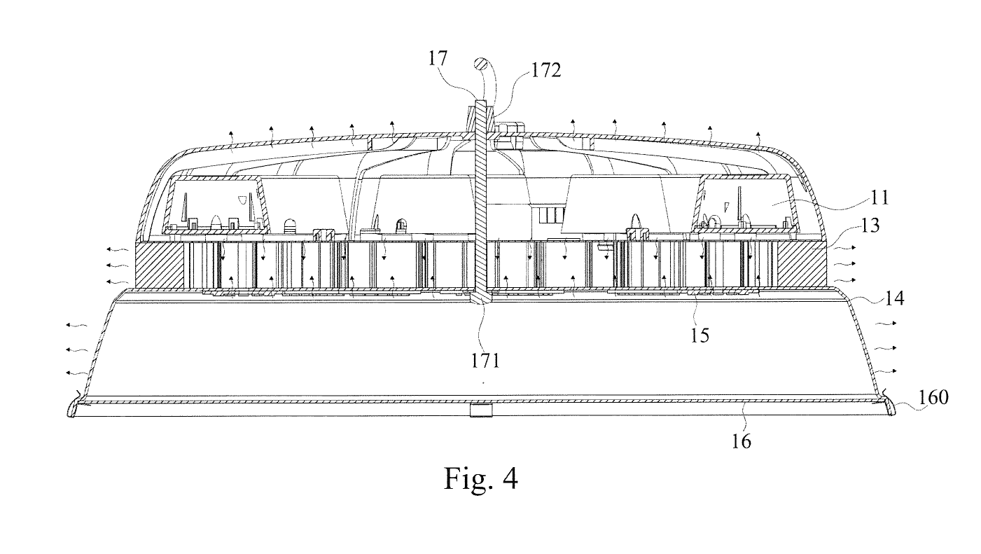

With reference to FIG. 4 for a cross-sectional side view of a preferred embodiment of the present invention, the circuit board of each separate LED module 15 is installed with an LED, and the LED modules 15 are installed with a gap apart from each other, so that the heat released from the LED will not be concentrated at the same circuit board. In other words, the LED modules 15 distributed and attached in the lamp base 14 assist dissipating heat to the surface of the lamp base 14. The lamp base 14 is made of aluminum, such that the property of aluminum can achieve the effect of conducting the heat to the heat dissipating module 13 that is closely attached to the lamp base 14, while dissipating the heat from the lamp base 14. In addition, the hot air inside the lamp base 14 can flow through the airholes 140 into the heat dissipating module 13 according to the principle of the rising hot airflow and disperse from the heat dissipating module 13, or after the hot air flows through the heat dissipating holes 120 of the substrate 12, the hot air is discharged through the penetrating holes 100 of the lamp cover 10 to expedite a temperature drop of the lamp base 14, so as to prevent the LED modules 15 from being damaged and improve the service life.

Further, electric energy is converted into heat energy during the operation of the power supply devices 11. Now, the heat energy can be conducted quickly through the substrate 12 made of iron to the heat dissipating module 13, or can be passed through the penetrating holes 100 to the outside, so as to reduce the temperature of the power supply devices 11 and improve the service life.

In summation of the description above, the high-performance heat dissipating lamp 1 of the present invention can improve the thermal conductivity and the heat dissipation speed by the substrate 12 and the lamp base 14 made of metal, and the aluminum extruded fins of the heat dissipating module 13 can be used to increase the heat dissipating area, and the gaps between the heat dissipating elements 130 can guide the airflow to produce the thermal convection effect. In the meantime, the airholes 140, the heat dissipating holes 120 and the penetrating holes 100 are provided for discharging the hot rising air to achieve the high-performance heat dissipating effect of the high power lamp.

What is claimed is:

1. A high-performance heat dissipating lamp, comprising:
a lamp cover;
a plurality of power supply devices;
a substrate, with a side coupled to a cover opening of the lamp cover, and having a plurality of heat dissipating holes, and the power supply devices being installed on the substrate and covered inside the lamp cover;
a heat dissipating module, with a side attached onto the other side of the substrate;
a lamp base, attached onto the other side of the heat dissipating module, and having a containing space;
a plurality of LED modules, contained in the containing space, fixed to the lamp base, and one-on-one coupled to the power supply devices respectively; and
a translucent plate, coupled to and sealed onto a base opening of the lamp base.

2. The high-performance heat dissipating lamp of claim 1, wherein the heat dissipating module comprises a plurality of heat dissipating elements arranged with a gap apart from each other and disposed along the periphery of the substrate.

3. The high-performance heat dissipating lamp of claim 2, wherein the heat dissipating elements are a plurality of fishbone-shape fins extended from a V-shaped center portion towards both ends of an opening respectively, such that the heat dissipating elements are installed in a fan shape symmetrically on both left and right sides.

4. The high-performance heat dissipating lamp of claim 1, wherein the lamp cover has a plurality of penetrating holes formed on a surface of the lamp cover, and each of the penetrating holes is in a circular cylindrical shape, and the penetrating holes are arranged centripetally.

5. The high-performance heat dissipating lamp of claim 1, wherein the lamp cover, the substrate and the lamp base separately have a through hole formed at a center position thereof.

6. The high-performance heat dissipating lamp of claim 5, further comprising a hanging rod and a hanging ring, and the hanging rod passing through the through holes and fixing to the hanging ring.

7. The high-performance heat dissipating lamp of claim 1, wherein the substrate is made of metal or plastic.

8. The high-performance heat dissipating lamp of claim 1, wherein the lamp base is made of aluminum, and the lamp base has a plurality of airholes formed on a surface of the lamp base.
